(19) United States
(12) Patent Application Publication
(10) Pub. No.: US 2006/0228935 A1
(43) Pub. Date: Oct. 12, 2006

(54) [HIGH-FREQUENCY TRANSMISSION CABLE]

(75) Inventors: Chung-Shih Wen, TAIPEI (TW); Chang-Pin Wang, TAIPEI (TW)

Correspondence Address: SURE-FIRE ELECTRICAL CORPORATION, 2F-4, NO. 148, SEC. 4, CHUNG HSIAD E. ROAD, TAIPEI, TW

(73) Assignee: SURE-FIRE ELECTRICAL CORPORATION, Hsinchuang City, Taipei Hsien. (TW)

(21) Appl. No.: 10/907,564

(22) Filed: Apr. 6, 2005

(51) Int. Cl. H01R 12/24

(52) U.S. Cl. 439/497

(57) ABSTRACT

A high-frequency transmission cable is disclosed to include a connector, which has the terminals thereof arranged into two vertically spaced rows, an adapter board, which is set in between the two rows of terminals of the connector to eliminate interference between the terminals during transmission of high-frequency signal and which has transmission circuits arranged on the top and bottom surfaces thereof and respectively soldered to the two rows of terminals of the connector, a metal grounding face set between the top surface and the bottom surface, and conducting holes respectively electrically connecting the transmission circuits to the metal grounding face, and a cable, which has an outer insulator and electric wires surrounded by the outer insulator and soldered with the conducting wires to the transmission circuits of the adapter board.

### BACKGROUND OF THE INVENTION

1. Field of the Invention

The present invention relates to high-frequency transmission cable and more particularly, to such a high-frequency transmission cable, which uses an adapter board to connect the connector to the cable, preventing interference between vertically spaced terminals during transmission of high-frequency signal.

2. Description of the Related Art

Following fast development of high technology, there is a big change in audio and video applications. Nowadays, video disk players, LCD TVs, video phones, conferencing facilities, and many other digital audio video apparatus have become popular in our life. These advanced audio and video apparatus employ digital technology to process audio and video data to fit different application demands. Related protocols have been continuously defined and modified to the perfect status. In order to have the users enjoy better sound and visual image quality, suppliers are trying hard to increase bandwidth for transmission of digital signal.

When using an electronic product (for example, TV, audio system, computer, etc.) to receive and reproduce digital signals, the electric connectors of the electronic product act an important role. The electric connectors of electronic products use as signal transmission media between parts or systems. The performance of the electric connectors determines system quality.

However, following increasing of system working frequency and miniaturization of electronic products, the internal terminals of the electric connectors are made relatively finer and arranged at a relatively higher density, in consequence, high frequency problems become serious. Among high frequency problems, crosstalk is the major one that affects the quality. FIG. 1 is a schematic drawing showing the arrangement of the terminals of a connector for high-frequency transmission cable according to the prior art. As illustrated, two signal terminals B1 are used with one grounding terminal B2 in each terminal set B; the signal terminals B1 and grounding terminal B2 of each terminal set B are arranged at two different elevations; the signal terminals B1 and grounding terminals B2 of two adjacent terminal sets B are arranged in a reversed manner to eliminate interference between the signal terminals B1 of the adjacent terminal sets B and to further prevent occurrence of crosstalk. This arrangement reduces the occurrence of crosstalk, however it does not fit the requirements of modern electronic's features such as light, short, thin and small.

Further, it is inconvenient to solder the connector to the cable according to the aforesaid arrangement. According to the aforesaid arrangement, the signal wires of the same set must be respectively soldered to two terminals at different elevations. This installation procedure is complicated, not suitable for mass production, thereby resulting in a high manufacturing cost. A high cost product is difficult to attract consumers to buy.

Further, impedance mismatch may occur after bonding of the connector to the cable according to the aforesaid prior art design, such impedance mismatch will cause a reflection, resulting in crosstalk that affects the quality of the reproduction of the signal.

FIG. 2 is a perspective view of a high-frequency transmission cable according to the prior art. As illustrated, the high-frequency transmission cable A is comprised of a connector A1 and a cable A2. The connector A1 comprises a plurality of terminals A11 extending out of the rear side. The cable A2 comprise a plurality of transmission wires A21 respectively soldered to the terminals A11, aluminum foils A22 wrapping the transmission wires A21, and thermoshrinking tubes A23 holding the transmission wires A21 in sets. In order to eliminate crosstalk, following measures may be employed.

a. Carefully stripping the insulative layer of each transmission wire A21, so as not to axially stretch the length of the insulative layer and the internal conductor that may cause change of the resistance, capacitance and inductance and affect the impedance of the cable A2.

b. Minimizing the exposed part of the internal conductor of each transmission wire A21.

c. Preventing curving of the internal conductor of each transmission wire A21, so as not to cause change of the resistance, capacitance and inductance and not to affect the impedance of the cable A2.

d. Minimizing the bonding area between the internal conductor of each transmission wire A21 and the connector A1, preventing antenna effect.

e. Arranging the transmission wires A21 in the respective thermoshrinking tubes A23 in a good order.

f. Keeping the aluminum foils A22 well packed on the transmission wires A21.

g. Quickly soldering the transmission wires A21 to the terminals A11, so as not to cause the insulative layer of each transmission wire A21 to shrink.

However, it is difficult to ensure and control the quality of the finished product after installation subject to the aforesaid measures. Due to installation limitations, the aforesaid prior art design has the following drawbacks.

1. It is difficult to ensure and control the quality of the finished product after a careful installation procedure, thereby resulting in a low yield rate.

2. In order to abide by the employed measures carefully, it is not practical to make the high-frequency transmission cable A with an automatic processing machine, and the complicated processing procedure requires much work time and labor, resulting in a high manufacturing cost.

CRT monitors have been used for TV sets and computers for long for the advantages of good picture quality of reasonable price. However, the leading role of CRT monitors in the market faces challenges from different planar displays including TFT LCDs and PDPs. Consumers do care about the content of TV programs as well as the quality of pictures. TFT LCDs and PDPs are developed to bring better picture quality to consumers. These apparatus use digital technology to process video data. For a better quality, the bandwidth should be relatively increased. However, a high bandwidth brings more crosstalk noises that cause a vague outline of the picture, affecting the quality of the images.

Therefore, it is desirable to provide a high-frequency transmission cable that eliminates crosstalk noises during transmission of high frequency signal.

### SUMMARY OF THE INVENTION

The present invention has been accomplished under the circumstances in view. It is therefore the main object of the present invention to provide a high-frequency transmission cable, which eliminates interference between vertically spaced terminals during transmission of high-frequency signal, preventing crosstalk noises. It is another object of the present invention to provide a high-frequency transmission cable, which is easy and inexpensive to manufacture.

To achieve these and other objects of the present invention, the high-frequency transmission cable comprises a cable, a connector, and an adapter board connected between the first end of the cable and the connector, wherein: the connector comprises a housing, the housing having a connecting side connectable to an electronic apparatus and a bonding side, and a plurality of terminals mounted inside the housing and arranged into two rows at different elevations outside the bonding side; the adapter board is set in between the two rows of terminals at the bonding side of the connector, comprising a top surface, a bottom surface, a plurality of transmission circuits arranged on the top and bottom surfaces and respectively connected to the terminals of the connector, at least one metal grounding face set between the top surface and the bottom surface, and a plurality of conducting holes respectively electrically connecting the transmission circuits to the metal grounding face; the cable comprises an outer insulator and a plurality of electric wires surrounded by the outer insulator, the electric wires comprising a plurality of conducting wires respectively connected to the transmission circuits of the adapter board.

### BRIEF DESCRIPTION OF THE DRAWINGS

FIG. 1 is a schematic drawing showing the arrangement of the terminals of a connector for high-frequency transmission cable according to the prior art.

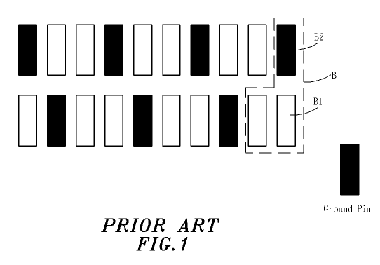

FIG. 2 is a perspective view of a high-frequency transmission cable according to the prior art.

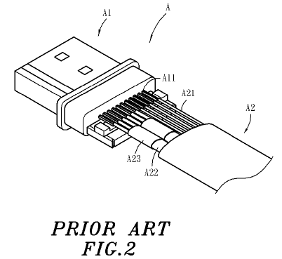

FIG. 3 is a perspective view of a high-frequency transmission cable according to the present invention.

FIG. 4 is an exploded view of the high-frequency transmission cable according to the present invention.

FIG. 5 is a front view of the circuit boards of the adapter board for the high-frequency transmission cable according to the present invention.

FIG. 5A is a bottom view of the circuit boards of the adapter board for the high-frequency transmission cable according to the present invention.

FIG. 6 is a schematic drawing showing the arrangement of the conducting wires of the electric wires of the cable on the circuit boards of the adapter board according to the present invention.

FIG. 7 is a perspective view of an alternate form of the high-frequency transmission cable according to the present invention.

FIG. 8 is an exploded view of another alternate form of the high-frequency transmission cable according to the present invention.

FIG. 9 is an exploded view of still another alternate form of the high-frequency transmission cable according to the present invention.

### DETAILED DESCRIPTION OF THE PREFERRED EMBODIMENT

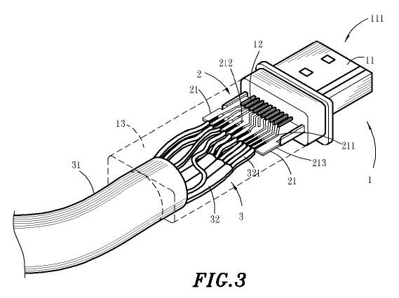

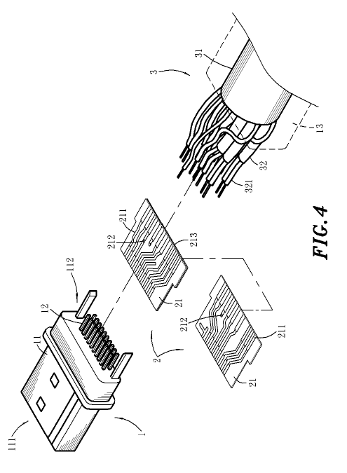

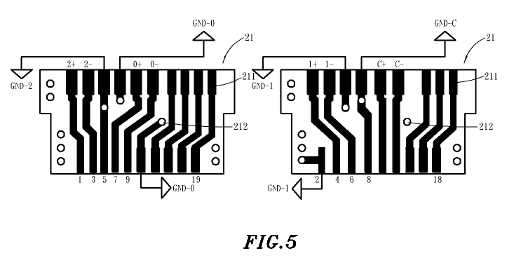

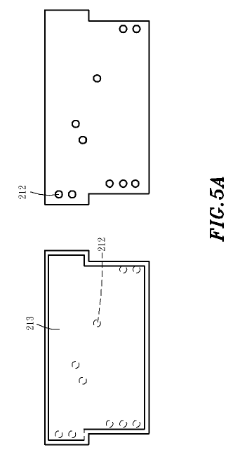

Referring to FIGS. 3, 4, 5, and 5A, a high-frequency transmission cable is shown comprising a connector 1, an adapter board 2, and a cable 3.

The connector 1 comprises a housing 11, which has a connecting side 111 connectable to an electronic apparatus (not shown) and a bonding side 112, and a plurality of terminals 12 mounted inside the housing 11 and arranged into two rows at two different elevations outside the bonding side 112.

The adapter board 2 is comprised of two circuit boards 21. Each circuit board 21 comprises a plurality of transmission circuits 211 and a plurality of conducting holes 212 respectively electrically connected to the transmission circuits 211. One circuit board 21 has a metal grounding face 213 disposed at the bottom side and electrically connected to the respective conducting holes 212.

The cable 3 comprises an outer insulator 31 and a plurality of electric wires 32 surrounded by the outer insulator 31. Each electric wire 32 comprises a plurality of conducting wires 321.

During assembly process, the two circuit boards 21 are reversely arranged in a stack, keeping the transmission circuits 211 of the two circuit boards 21 at the top and bottom sides of the adapter board 2 and the metal grounding face 213 disposed between the circuit boards 21. Thus, the transmission circuits 211 of the circuit boards 21 are electrically connected to the metal grounding face 213 through the conducting holes 212. Thereafter, the adapter board 2 is set in between the two vertically spaced rows of terminals 12, and then the terminals 12 are respectively soldered to one end of each of the transmission circuits 211 of the circuit boards 21, and then the electric wires 32 of the cable 3 are respectively soldered to the other end of each of the transmission circuits 211 of the circuit boards 21.

After connection of the connecting side 111 of the connector 1 to an electronic apparatus for high-frequency signal transmission, the metal grounding face 213 of the adapter board 2 prevents signal interference between the transmission circuits 211 of the two circuit boards 21, thereby eliminating cross-talk noises. Further, each circuit board 21 provides an electromagnetic wave insolating function. Therefore, the adapter board 2 effectively eliminates interference between the transmission circuits 211 of the two circuit boards 21 during transmission of high-frequency signal.

Further, the conducting holes 212 are capable of guiding cross-talk noises from the grounding conducting wire of the conducting wires 321 of the electric wires 32 of the cable 3 to the metal grounding face 213, so that the connected electronic apparatus can receive clear signal for output, providing high quality visual images.

Further, during transmission of high frequency signal, the coefficient of the whole inductance, capacitance and impedance must match. Impedance mismatch will result in signal attenuation and crosstalk noises, i.e., the impedance of the adapter board 2 must be close or equal to that of the cable 3. Therefore, the size of the metal grounding face 213 of the adapter board 2 can be adjusted subject to the length of the cable 3 to prevent mismatch of impedance between the adapter board 2 and the cable 3.

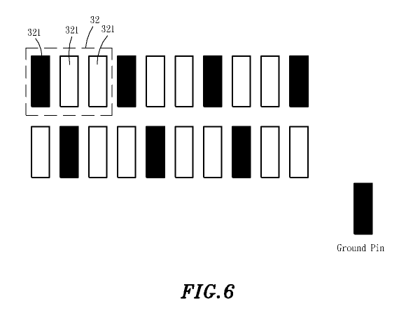

Referring to FIG. 6 and FIG. 3 again, the high-frequency transmission cable of the present invention uses the circuit boards 21 and metal grounding face 213 of the adapter board 2 to eliminate interference between the transmission circuits 211 of the two circuit boards 21. When bonding the cable 3 to the adapter board 2, the worker needs only to consider interference between the horizontally arranged electric wires 32. Therefore, when connecting the cable 3 to the adapter board 2, the conducting wires 321 of the electric wires 32 are soldered to the transmission circuits 211 on the same surface, and the grounding conducting wires of the conducting wires 321 work to insolate signal conducting wires of the conducting wires 321, preventing interference between the electric wires 32. Because the conducting wires 321 of each electric wire 32 are soldered to the transmission circuits 211 on the same surface, the invention eliminates the drawbacks of the prior art design in which the signal terminal and grounding terminal of each terminal set are arranged at two different elevations, and the signal terminals and grounding terminals of each two adjacent terminal sets are arranged in a reversed manner. Further, a metal shield 13 is provided and covered over the bonding side 112 of the respective connector 1 and a part of the cable 3.

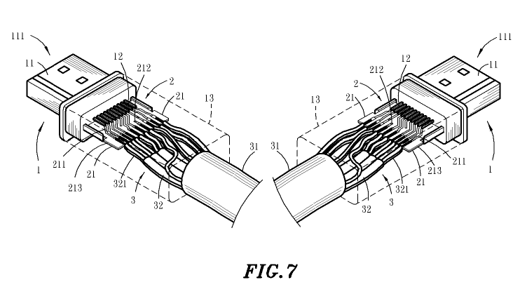

FIG. 7 shows an alternate form of the present invention. According to this embodiment, the cable 3 has two ends respectively mounted with a respective adapter board 2 and a respective connector 1, and a metal shield 13 is provided at each of the two ends of the cable 3 and covered over the bonding side 112 of the respective connector 1.

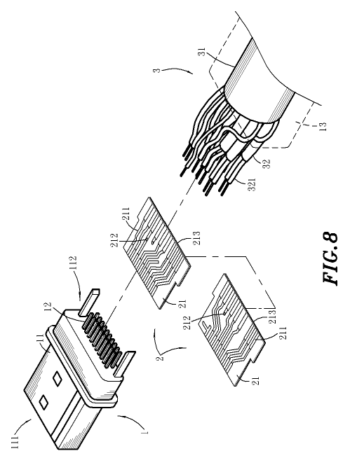

FIG. 8 shows another alternate form of the present invention. According to this embodiment, the adapter board 2 is comprised of two circuit boards 21. Each circuit board 21 comprises a plurality of transmission circuits 211 on the top surface, a metal grounding face 213 on the bottom surface, and a plurality of conducting holes 212 respectively electrically connected between the transmission circuits 211 and the metal grounding face 213. This embodiment has two metal grounding faces 213 respectively disposed at the top and bottom sides of the adapter board 2 to eliminate interference between the transmission circuits 211 of the two circuit boards 21 during transmission of high-frequency signal.

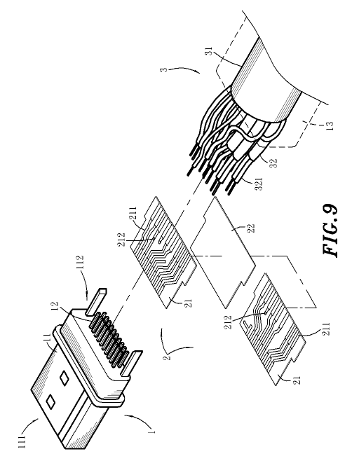

FIG. 9 shows still anther alternate form of the present invention. According to this embodiment, the adapter board 2 is comprised of two circuit boards 21 and a metal plate member 22. Each circuit board 21 comprises a plurality of transmission circuits 211 on the top surface, and a plurality of conducting holes 212 respectively electrically connected to the transmission circuits 211. During installation, the metal plate member 22 is sandwiched in between the circuit boards 21 and maintained in close contact with the conducting holes 212. When installed, the transmission circuits 211 are electrically connected to the metal plate member 22 through the conducting holes 212.

As indicated above, the technical features of the present invention that eliminate the drawbacks of the prior art designs are as follows.

1. The invention uses the metal grounding surface between the two circuit boards of the adapter board to eliminate interference between the transmission circuits at the top and bottom sides of the adapter board during transmission of high-frequency signal, preventing crosstalk noises. Further, each circuit board provides an electromagnetic wave insolating function, enhancing the function of the adapter board to eliminate interference between the transmission circuits of the two circuit boards.

2. By means of adjusting the size of the metal grounding face subject to the length of the cable, the impedance of the adapter board and the impedance of the cable match, preventing signal attenuation and crosstalk noises.

3. The high-frequency transmission cable of the present invention uses the circuit boards and metal grounding face of the adapter board to eliminate interference between the transmission circuits at the top and bottom sides of the adapter board during transmission of high-frequency signal, therefore the conducting wires of each electric wire can be soldered to the transmission circuits of the adapter board on the same surface, enabling the grounding conducting wires of the conducting wires to isolate the signal conducting wires of the conducting wires and to further prevent interference between the electric wires. Because the conducting wires of each electric wire are soldered to the transmission circuits on the same surface, the invention eliminates the drawbacks of the prior art design in which the signal terminal and grounding terminal of each terminal set are arranged at two different elevations, and the signal terminals and grounding terminals of each two adjacent terminal sets are arranged in a reversed manner.

A prototype of high-frequency transmission cable has been constructed with the features of FIGS. 3-9. The high-frequency transmission cable functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A high-frequency transmission cable connector comprising a cable, a connector, and an adapter board connected between a first end of said cable and said connector, wherein:
said connector comprises a housing, said housing having a connecting side connectable to an electronic apparatus and a bonding side, and a plurality of terminals mounted inside said housing and arranged into two rows at different elevations outside said bonding side;
said adapter board is set between the two rows of terminals at the bonding side of said connector, comprising at least one circuit board, a plurality of transmission circuits arranged on a top surface and a metal grounding plate disposed on a bottom surface of said circuit board respectively and a plurality of conducting holes respectively electrically connecting said transmission circuits to said metal grounding plate, wherein said transmission circuits are respectively connected to the terminals of said connector; and
said cable comprises an outer insulator and a plurality of electric wires surrounded by said outer insulator, said electric wires comprising a plurality of conducting wires respectively connected to the transmission circuits of said adapter board.

2. The high-frequency transmission cable connector of claim 1, wherein said adapter board comprises two circuit boards.

3. (canceled)

4. The high-frequency transmission cable connector as claimed in claim 1, further comprising a second connector, and a second adapter board connected between a second end of said cable and said second connector.

5. The high-frequency transmission cable connector as claimed in claim 1, further comprising a metal shield covered over the bonding side of said connector and a part of the first end of said cable.

6. A high-frequency transmission cable connector comprising a cable, a connector, a metal plate member and an adapter board connected between a first end of said cable and said connector, wherein:
said connector comprises a housing, said housing having a connecting side connectable to an electronic apparatus and a bonding side, and a plurality of terminals mounted inside said housing and arranged into two rows at different elevations outside said bonding side;
said adapter board is set in between the two rows of terminals at the bonding side of said connector, comprising at least one circuit board, a plurality of transmission circuits arranged on a top surface of said circuit board and a plurality of conducting holes formed in said circuit board;
a metal plate member set at a bottom surface of said adapter board, wherein said conducting holes formed in said circuit board respectively electrically connect said transmission circuits to said metal plate member; and
said cable comprises an outer insulator and a plurality of electric wires surrounded by said outer insulator, sad electric wires comprising a plurality of conducting wires respectively connected to the transmission circuits of said adapter board.

7. The high-frequency transmission cable connector of claim. 6, wherein said adapter board comprises two circuit boards.

8. The high-frequency transmission cable connector as claimed in claim 6, further comprising a second connector, and a second adapter board connected between a second end of said cable and said second connector.

9. The high-frequency transmission cable connector as claimed in claim 6, further comprising a metal shield covered over the bonding side of said connector and a part of the first end of said cable.
